(19) United States
(12) Patent Application Publication
(10) Pub. No.: US 2025/0261803 A1
(43) Pub. Date: Aug. 21, 2025

(54) STIR-FRYING MACHINE

(71) Applicant: Jianwei ZHANG, Kaohsiung City (TW)

(72) Inventor: Jianwei ZHANG, Kaohsiung City (TW)

(21) Appl. No.: 17/637,787

(22) PCT Filed: Sep. 2, 2019
(86) PCT No.: PCT/CN2019/103960

§ 371 Date: Feb. 23, 2022

(30) Foreign Application Priority Data
Aug. 19, 2019 (CN) 201910766143.6

(51) Int. Cl. A47J 43/07; A47J 36/02; A47J 36/32; A47J 36/34; A47J 43/08; B08B 9/08

(52) U.S. Cl. CPC A47J 43/075; A47J 36/025; A47J 36/32; A47J 36/34; A47J 43/08; B08B 9/0813

(57) ABSTRACT

A food stir-frying machine is disclosed. A base is disposed on a stand. A stir-frying drum is provided in the base. A stirrer is fixed in the stir-frying drum. A heating unit is provided under the stir-frying drum to heat food in the stir-frying drum. The stirrer in the stir-frying drum helps to evenly and completely heat the food. After the food has been cooked, an overturning unit rotates the stir-frying drum to dump the food therein into a container on a tray platform of the outputting unit. A driving source of the outputting unit pushes the container on the tray platform out of the stand, so that the cooked food in the container can be taken easily. A cleaning unit is used for cleaning the stir-frying drum and a material guiding hopper, and then the stir-frying drum is returned to the original position.

### BACKGROUND

### Technical Field

The invention relates to cooking machines, particularly to a stir-frying machine.

### Related Art

Stir-frying must be implemented by professional cooks with hands in kitchens. The processes of stir-frying include the approaches of stirring and flipping. Thus, it takes a lot of time and effort to make a rich dish, especially when facing many eaters, there is always a sense of lack of manpower.

As a result, the inventor of the present application invented an automatic stir-frying machine (Taiwan patent No. I445512). The machine includes a stand, a base, a heating unit, an overturning unit, a container, a cleaning unit, a draining device and a control unit. The base is pivoted on the stand and is disposed with a power source. A spindle of the power source is connected with a stir-frying drum for holding food materials. The heating unit is installed on the base and under the stir-frying drum. The overturning unit is installed on the base for tilting or restoring the base by power. The container is disposed in the stand for holding the cooked food dumped by tilting. The container can be drawn out of or stored in the stand. The cleaning unit is installed on the stand and corresponds to the stir-frying drum which is tilted for washing with spraying. The draining device has a plate in the stand. The plate is formed with multiple holes. A funnel is disposed in the stand and under the plate for separating the water with kitchen waste and draining wastewater. The controller is installed in the stand and has an operation panel for controlling the action time and the heating temperature of the automatic stir-frying machine. Thereby, food materials can be rapidly and simply stir-fried by the stir-frying of the stir-frying machine to accomplish the functions of automatic stir-frying and saving labor costs and working hours.

In TW I445512, food materials are placed in the stir-frying drum and then are rolled and stir-fried in the stir-frying drum by rotation thereof. However, because of the single rotation of the stir-frying drum, when food materials are moved and stir-fried in the stir-frying drum, the food materials usually gather at a place, especially for sticky meat, which is easy to tangle together. This causes the food materials cannot be completely heated from the outside to the inside. In other words, the outsides of food materials are well cooked but the insides are not.

The stir-frying drum of a current automatic stir-frying machine is provided with a stir-frying assistance component such as a spatula, a spatula knife, a scraper, a blocker, a scroll, or a blade to improve the function of stir-frying, but such a stir-frying assistance component is not integrated formed with the stir-frying drum, so the stir-frying drum is very complicated in structure and gaps are formed between the stir-frying assistance and the stir-frying drum. These gaps not only clamp food but also increase difficulty in washing the stir-frying drum to cause incomplete washing during the automatic washing process. Thus, in practice, the stir-frying drum still needs manual washing which is time-consuming and labor-intensive. Also, because the stir-frying assistance and the stir-frying drum are separable, the juice in the stir-frying drum often leaks out when stir-frying, or the rubber ring in the junction will age to cause oil leakage or infiltrating the stir-frying drum to form a risk of food safety.

In TW I445512, food materials in the stir-frying drum, which have been completely cooked, will fall in a holding tray, and the holding tray will be drawn by a worker. However, such a combinative operation of labor and machine tends to affect the normal work of the machine and reduce the smoothness of processes and the working efficiency due to human factors. Also, when the stir-fried food is heavy, it will take a lot of effort to pull out the holding tray by manpower, which will cause a greater burden on the operator's body and easily lead to fatigue and injury of the operator in the long run. When the holding tray accidentally falls to the ground when pulling out the holding tray, there will be dangers such as being hit by the holding tray or being scalded by hot food.

In view of this, the inventors have devoted themselves to the above-mentioned prior art, researched intensively, and cooperated with the application of science to try to solve the above-mentioned problems. Finally, the invention which is reasonable and effective to overcome the above drawbacks is provided.

### SUMMARY

An object of the invention is to provide a stir-frying machine which overcomes the drawbacks of prior-art stir-frying machines and is able to evenly stir-fry food material and automatically wash the stir-frying drum after completing stir-frying.

To accomplish the above object, the invention provides a stir-frying machine including:
a stand;
a stir-frying unit, disposed with a base rotatably connected to the stand, the base being disposed with a rotary power source, and a spindle of the rotary power source being connected with a stir-frying drum;
a heating unit, installed on the base and under the stir-frying drum, and disposed with a heating source;
an overturning unit, installed on the stand, disposed with a first driving source, and an output shaft of the first driving source connecting with the base;
a material guiding unit, comprising a material guiding platform under the base of the stir-frying unit, a central portion of the material guiding platform being disposed with a material guiding hopper, and two sides of the material guiding platform being fixed to the stand;
an outputting unit, comprising a tray platform under the material guiding unit and a second driving source installed on the stand, the tray platform being formed with a container placing space and a cleaning hopper, each of two sides of the tray platform being fixed to one of two inner walls of the stand with a sliding unit to make the tray platform and the stand form a slidable connection, and an output shaft of the second driving source connecting with the tray platform; and
a cleaning unit, comprising a material guiding hopper washing pipeline and a stir-frying drum washing pipeline, the material guiding hopper washing pipeline being disposed behind the tray platform and extending to a position over the cleaning hopper, an outlet of the material guiding hopper washing pipeline being toward the material guiding hopper, a stir-frying drum washing pipeline the stir-frying drum washing pipeline being disposed at a front of the stand and extending to a position over the material guiding hopper, and an outlet of the stir-frying drum washing pipeline being toward the stir-frying drum.

In the stir-frying machine of the invention, inner walls of the material guiding hopper of the material guiding unit form an inclination angle of 70-75 degrees from top to bottom, and the inner walls of the material guiding hopper are coated with a non-stick layer.

In the stir-frying machine of the invention, each of two sides of the material guiding platform of the material guiding unit is fixed to the stand through a sliding unit to make the material guiding platform and the stand form a slidable connection.

In the stir-frying machine of the invention, the stir-frying drum is formed with a chamber, a bottom of the chamber is closed, a top of the chamber, which is opposite to the bottom, is formed with an opening, a chamber height is formed between the top of the chamber and the opening of the chamber, the chamber of the stir-frying drum is provided with a stirrer, the stirrer and the stir-frying drum are integratedly formed in one piece, a side of the stirrer, which is adjacent to an inner wall of the chamber of the stir-frying drum is defined as a first side, the first side is integratedly connected with the inner wall of the chamber, a junction between the first side of the stirrer and the chamber of the stir-frying drum forms an arcuate chamfer, a length of the first side of the stirrer is not greater than the chamber height of the chamber of the stir-frying drum, another side of the stirrer, which is opposite to the first side of the stirrer, is defined as a second side, the second side is integratedly formed with a spatula sheet with an angle against the stirrer, a side of the stirrer, which is adjacent to the bottom of the chamber of the stir-frying drum is defined as a third side, the third side is integratedly connected with the bottom of the chamber of the stir-frying drum, and a length of the third side is greater than a radius of the bottom of the chamber.

The stir-frying machine of the invention further includes a first sensor, a second sensor, a third sensor, an alarm and a main controller, wherein the first sensor, the second sensor, the third sensor, the alarm and the main controller are installed on the stand, the first sensor is disposed at a position corresponding to the stir-frying unit for sensing if the stir-frying drum rotates or not, the second sensor is disposed at a position corresponding to the tray platform and the container on the tray platform for sensing if the container is placed on the tray platform or not, the third sensor is installed on the main controller for sensing a current load of the rotary power source of the stir-frying unit, the main controller has a built-in automatic stir-frying program, and the first sensor, the second sensor, the third sensor, the alarm, the rotary power source of the stir-frying unit, the first driving source of the overturning unit and the second driving source of the outputting unit are wiredly or wirelessly connected with the main controller.

In the stir-frying machine of the invention, a remote temperature sensor is disposed at a position of the base, which corresponds to the stir-frying drum, there is a distance between the remote temperature sensor and the stir-frying drum to detect a stir-frying temperature of the stir-frying drum, the remote temperature sensor is connected to the heating source, a temperature of the heating source is controlled by the remote temperature sensor, and the remote temperature sensor is wiredly or wirelessly connected with the main controller of the control unit.

In the stir-frying machine of the invention, the material guiding hopper washing pipeline and the stir-frying drum washing pipeline of the cleaning unit are connected with a water source, and the water source is wiredly or wirelessly connected with the main controller of the control unit.

The stir-frying machine of the invention further includes an operating unit wiredly or wirelessly connected with the main controller of the control unit.

In the stir-frying machine of the invention, the stand is connected with a kitchen waste draining channel under the tray platform, the kitchen waste draining channel is arranged aslant from top to bottom, a kitchen waste collecting unit is disposed under the kitchen waste draining channel, the kitchen waste collecting unit is formed with a kitchen waste separating tank, a dryness/wetness separating member is disposed in the kitchen waste separating tank, and a bottom of the kitchen waste collecting unit is connected with at least one drain tube communicating with the kitchen waste separating tank.

In the stir-frying machine of the invention, the stand is multiple in number, the stands are arranged in parallel, each stand is connected with a kitchen waste draining channel under the tray platform, each kitchen waste draining channel is arranged aslant from top to bottom, a kitchen waste collecting unit is jointly disposed under the kitchen waste draining channels, the kitchen waste collecting unit is formed with a kitchen waste separating tank, a dryness/wetness separating member is disposed in the kitchen waste separating tank, and a bottom of the kitchen waste collecting unit is connected with at least one drain tube communicating with the kitchen waste separating tank.

In comparison with the related are, the invention has the following functions. When using the stir-frying machine of the invention, the stirrer of the stir-frying drum can evenly stir food materials and sufficiently heat them. After food materials have been cooked, the overturning unit makes food materials in the stir-frying drum fall in the container on the tray platform of the outputting unit through a material guiding hopper. After that, the driving source of the outputting unit forward pushes the tray platform out of the stand to be easy to take the dish in the container. At this time, the material guiding hopper washing pipeline disposed behind the tray platform is pushed to be under the material guiding hopper, so that the material guiding hopper washing pipeline and the stir-frying drum washing pipeline washing pipeline simultaneously wash the inner walls of the material guiding hopper and the stir-frying drum, respectively. After that, the opening of the stir-frying drum returns to the original standby position again. As a result, automatic tilting of pans, automatic stir-frying of food materials, automatic temperature control, automatic cooking of food materials, automatic dumping of food materials, automatic dish launch, automatic cleaning of the stir-frying drum and the material guiding hopper, and automatic repositioning of the stir-frying drum can be accomplished.

### BRIEF DESCRIPTION OF THE DRAWINGS

FIG. 1 is an exploded view of the invention;

FIG. 2 is a perspective view of the invention;

FIG. 3 is a cross-sectional view of the invention;

FIG. 4 is a schematic view of the connection framework of the control unit of the invention;

FIG. 5 is a cross-sectional view of the invention in a food materials stir-frying status;

FIG. 6 is a cross-sectional view of the invention in a food materials dumping status;

FIG. 7 is a cross-sectional view of the invention in a washing status; and

FIG. 8 is a cross-sectional view of the invention in a kitchen waste separating status.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

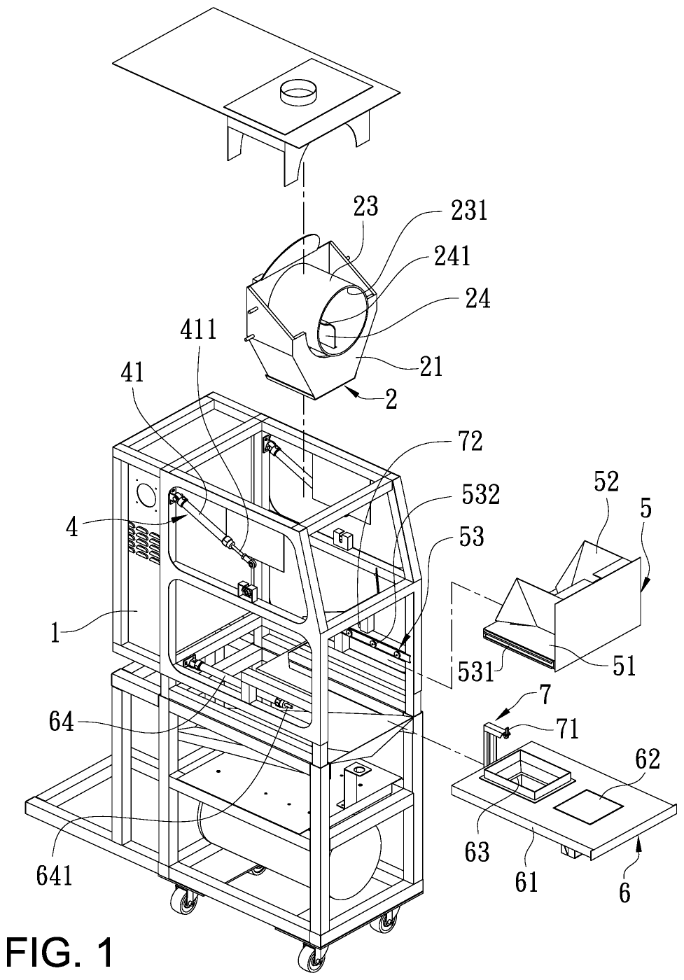

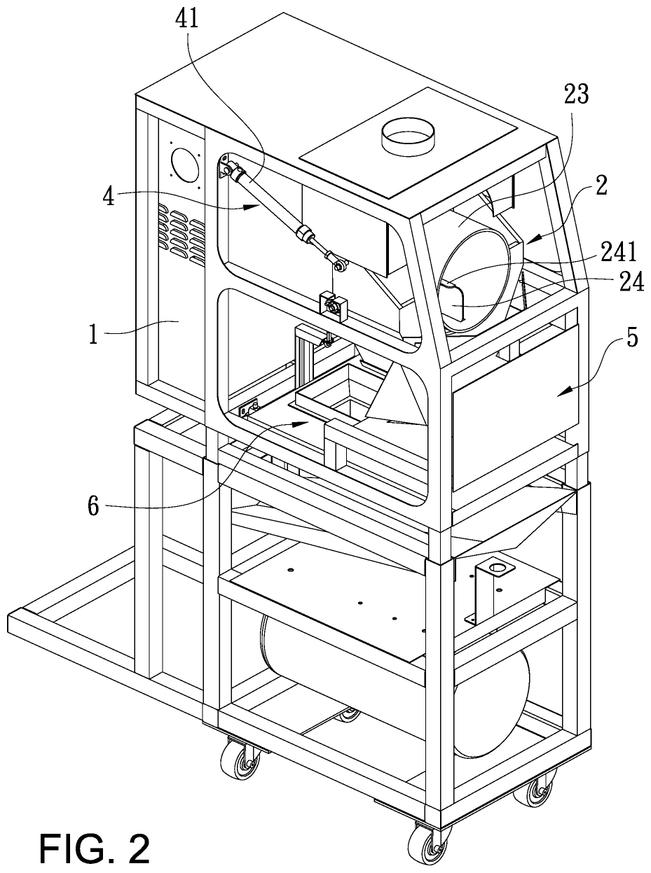

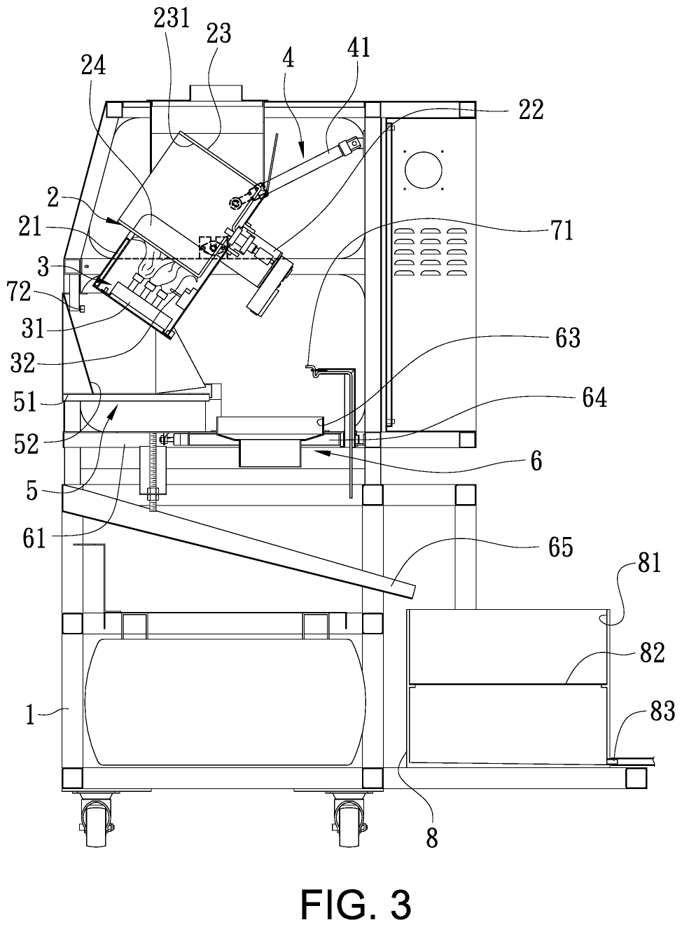

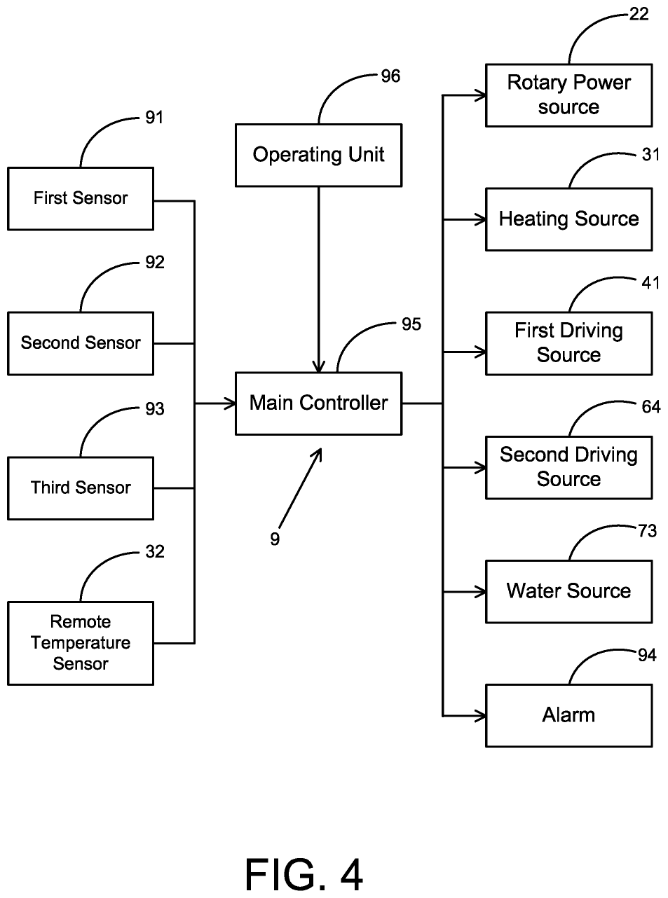

Please refer to FIGS. 1-4. The stir-frying machine of the invention includes a stand 1, a stir-frying unit 2, a heating unit 3, an overturning unit 4, a material guiding unit 5, an outputting unit 6, a cleaning unit 7, a kitchen waste collecting unit 8, and a control unit 9.

The stir-frying unit 2 is disposed with a base 21 rotatably connected to the stand 1. The base 21 is disposed with an electric motor serving as a rotary power source 22. A spindle of the rotary power source 22 is connected with a stir-frying drum 23 for holding food materials. The stir-frying drum 23 is formed with a chamber 231. The bottom of the chamber 231 is closed. The top of the chamber 231, which is opposite to the bottom, is formed with an opening. A chamber height is formed between the top of the chamber 231 and the opening of the chamber 231. The chamber 231 of the stir-frying drum 23 is provided with a stirrer 24, which is of a substantial L-shape. The stirrer 24 and the stir-frying drum 23 are integrally formed in one piece. A side of the stirrer 24, which is adjacent to an inner wall of the chamber 231 of the stir-frying drum 23, is defined as a first side. The first side is integrally connected with the inner wall of the chamber 231. The junction between the first side of the stirrer 24 and the chamber 231 of the stir-frying drum 23 forms an arcuate chamfer. A length of the first side of the stirrer 24 is not greater than the chamber height of the chamber 231 of the stir-frying drum 23. The other side of the stirrer 24, which is opposite to the first side of the stirrer 24, is defined as a second side. The second side is integrally formed with a spatula sheet 241 with an angle against the stirrer 24. A side of the stirrer 24, which is adjacent to the bottom of the chamber 231 of the stir-frying drum 23, is defined as a third side. The third side is integrally connected with the bottom of the chamber 231 of the stir-frying drum 23. A length of the third side is slightly greater than a radius of the bottom of the chamber 231.

The heating unit is installed on the base 21 and under the stir-frying drum 23. The heating unit 3 may be a gas furnace, an electric furnace, or a high frequency furnace. The heating unit 3 includes a heating source 31. The heating source 31 may be a head of a gas furnace, an electric furnace or a high frequency furnace. A remote temperature sensor 32 is disposed at a position of the base 21, which corresponds to the stir-frying drum 23. There is a proper distance between the remote temperature sensor 32 and the stir-frying drum 23 to detect the stir-frying temperature of the stir-frying drum 23. The remote temperature sensor 32 is connected to the heating source 31. Temperature of the heating source 31 is controlled to timely adjust the heating power of the heating source 31. Thus, the stir-frying drum 23 can keep a proper stir-frying temperature.

The overturning unit 4 is installed on the stand 1 and disposed of with at least one first driving source 41. The invention installs a first driving source 41 on each of two sides of the stand 1. The first driving source 41 is a power cylinder. An output shaft 411 of the first driving source 41 is pivotedly connected with the base 21 of the stir-frying unit 2 to make the first driving source 41 move the base 21 to frontward tilt or restore through the output shaft 411.

The material guiding unit 5 includes a material guiding platform 51 under the base 21 of the stir-frying unit 2. A central portion of the material guiding platform 51 is disposed with a material guiding hopper 52. Inner walls of the material guiding hopper 52 form an inclination angle of 70-75 degrees from top to bottom. The inner walls of the material guiding hopper 52 are coated with a non-stick layer. Each of two sides of the material guiding platform 51 is fixed to the stand 1 through a sliding unit 53 to make the material guiding platform 51 and the stand 1 form a slidable connection. The two sliding units 53 include two U-shaped sliding rails 53 disposed on two sides of the material guiding platform 51 and multiple rail wheels 532 disposed on inner walls of two sides of the stand 1 and corresponding to the two U-shaped sliding rails 531 in position. The rail wheels 532 are slidably disposed to the U-shaped sliding rails 531 of the material guiding platform 51.

The outputting unit 6 includes a tray platform 61 under the material guiding unit 5 and at least one second driving source 64, which is a power cylinder and installed on the stand 1. The tray platform is formed with a container placing space 62 and a cleaning hopper 63. The container placing space 62 may be a recess or a through hole. Each of two sides of the tray platform 61 is fixed to one of two inner walls of the stand 1 with a sliding unit to make the tray platform 61 and the stand 1 form a slidable connection. The second driving source 64 is disposed on the stand 1. An output shaft 641 of the second driving source 64 connects with the tray platform 61. The stand 1 is connected with a kitchen waste draining channel 65, which is arranged aslant from top to bottom.

The cleaning unit 7 includes a material guiding hopper washing pipeline 71 and a stir-frying drum washing pipeline 72. The material guiding hopper washing pipeline 71 and the stir-frying drum washing pipeline 72 are connected with a water source 73. The material guiding hopper washing pipeline 71 is disposed behind the tray platform 71 and extends to a position over the cleaning hopper 63. An outlet of the material guiding hopper washing pipeline 71 is toward the material guiding hopper 52. The stir-frying drum washing pipeline 72 is disposed at the front of the stand 1 and extends to a position over the material guiding hopper 52. An outlet of the stir-frying drum washing pipeline 72 is toward the stir-frying drum 23.

The kitchen waste collecting unit 8 is disposed under the kitchen waste draining channel 65. The kitchen waste collecting unit 8 is formed with a kitchen waste separating tank 81. A dryness/wetness separating member 82, which may be a mesh, is disposed in the kitchen waste separating tank 81. The bottom of the kitchen waste collecting unit 8 is connected with at least one drain tube 83 communicating with the kitchen waste separating tank 81. When the stir-frying machine has only one stand 1, one kitchen waste collecting unit 8 is disposed under the kitchen waste draining channel 65 of the stand 1, i.e., a one-to-one mode; while when the stir-frying machine has multiple stands 1 in parallel, one kitchen waste collecting unit 8 is jointly disposed under the kitchen waste draining channels 65 of the stands 1, i.e., a one-to-many mode.

The control unit 9 includes a first sensor 91, a second sensor 92, a third sensor 93, an alarm 94, and a main controller 95. The first sensor 91, the second sensor 92, the third sensor 93, the alarm 94, and the main controller 95 are installed on the stand 1. The first sensor 91 is disposed at a position corresponding to the stir-frying unit 2 for sensing if the stir-frying drum 23 rotates or not. The second sensor 92 is disposed at a position corresponding to the tray platform 61 and the container 10 on the tray platform 61 for sensing if the container 10 is placed on the tray platform 61 or not. The third sensor 93 is installed on the main controller 95 for sensing a current load of the rotary power source 22 of the stir-frying unit 2. The alarm 94 generates alarm sound or light. The main controller 95 has a built-in automatic stir-frying program, which presets specific operation seconds between any two adjacent processes of stir-frying, dumping food, pushing out the tray platform 61, washing the stir-frying drum 23 and the material guiding hopper 52, and returning the stir-frying drum 23 to serve as a buffer between two adjacent processes. Thus, an automatically continuous operation can be accomplished. The first sensor 91, the second sensor 92, the third sensor 93, the alarm 94, the rotary power source 22 of the stir-frying unit 2, the remote temperature sensor 32 of the heating unit 3, the first driving source 41 of the overturning unit 4, the second driving source 64 of the outputting unit 6 and the water source 72 of the cleaning unit 7 are wiredly or wirelessly connected with the main controller 95. An operating unit 96, which may be a smartphone, a tablet computer, a personal digital assistant, a touch panel, or a button panel, is disposed. The operating unit is wiredly or wirelessly connected with the main controller 95 of the control unit 9. The operating unit 96 sends an operation command to the main controller 95 of the control unit 9, then the main controller 95 controls each unit to start or stop and adjusts parameters of the stir-frying temperature and time of the automatic stir-frying program built in the main controller 95.

As a result, when using the stir-frying machine of the invention, a worker places food materials in the stir-frying drum 23 and sets parameters of heating time, temperature control, and rotational speed of the rotary power source 22 to the heating unit 86 via the operating unit 96, the worker can use the operating unit 96 to send a start signal to the main controller 95, and the main controller 95 drives each unit to automatically operate according to the automatic stir-frying program.

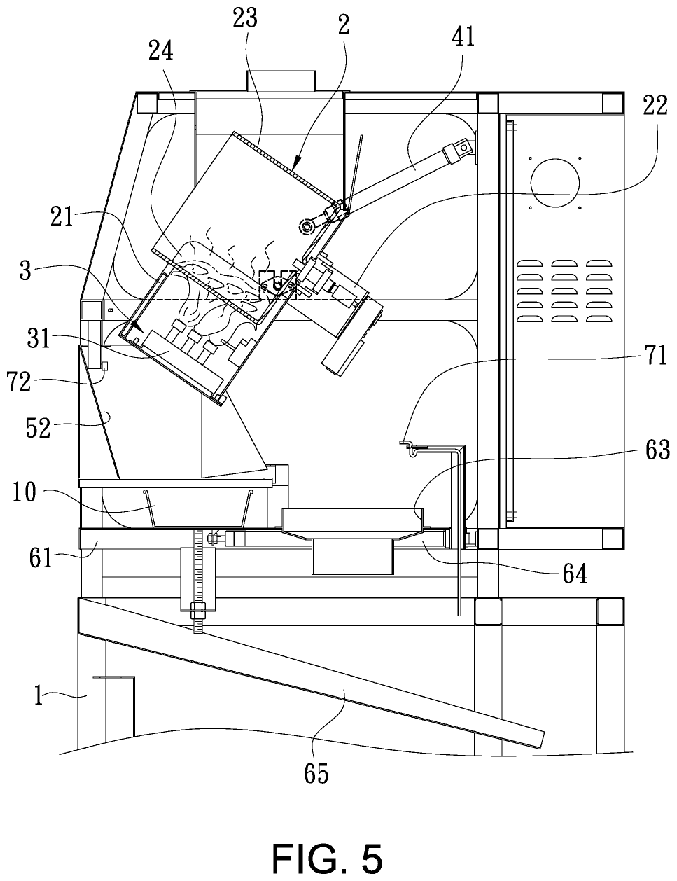

Please refer to FIG. 5. When the stir-frying drum 23 is rotated by the rotary power source 22, the food materials in the chamber 231 of the stir-frying drum 23 will be flipped by the rotation of the stir-frying drum 23. When the food materials touch the stirrer 24, using the best angle design of the stirrer 24 and associating with various rotational speed of the stir-frying drum 23, the food materials will generate a maximum tilt degree of freedom in the stir-frying drum 23. Also, after the stirrer 24 lifts the largest amount of food materials in the stir-frying drum 23, the time the lifted food materials stay in air will be extended and the falling speed of the food materials will be reduced. This can promote the food materials to be evenly heated. Accordingly, as the stirrer 24 repeatedly stir-fries food materials, the food materials can be completely cooked in a predetermined time to avoid incompletely stir-frying food materials or food materials tangling together or incompletely being heated.

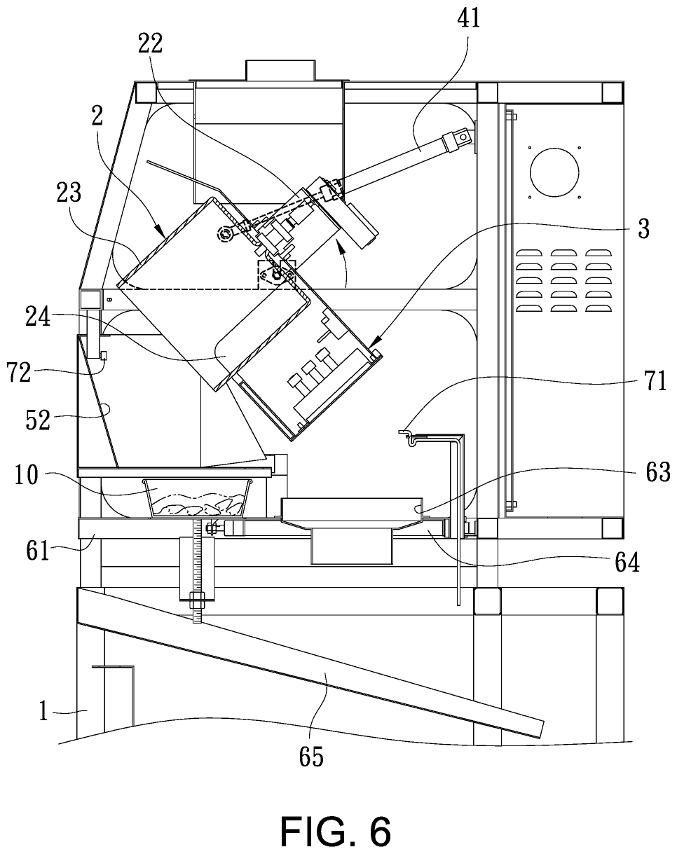

Please refer to FIG. 6. When the food materials have been cooked, the output shaft 411 of the first driving source 41 of the overturning unit 4 pushes the base 21 to forward tilt the stir-frying drum 23 installed on the base 21 by 45 to 50 degrees to dump the cooked food. The food dumped by the stir-frying drum 23 falls in the material guiding hopper 52 of the material guiding unit 5 and the food is concentrated by the material guiding hopper 52 and then falls in the container 10 placed on the container placing space 62 of the tray platform 61. When this action is completed, the second driving source 64 of the outputting unit 6 pushes the tray platform 61 forward through the output shaft 641 to stably push the container 10 on the tray platform 61 and the food therein out of the stand 1 along siding troughs on the inner walls of the stand 1. Thus, the container 10 can be easily taken from the tray platform 61.

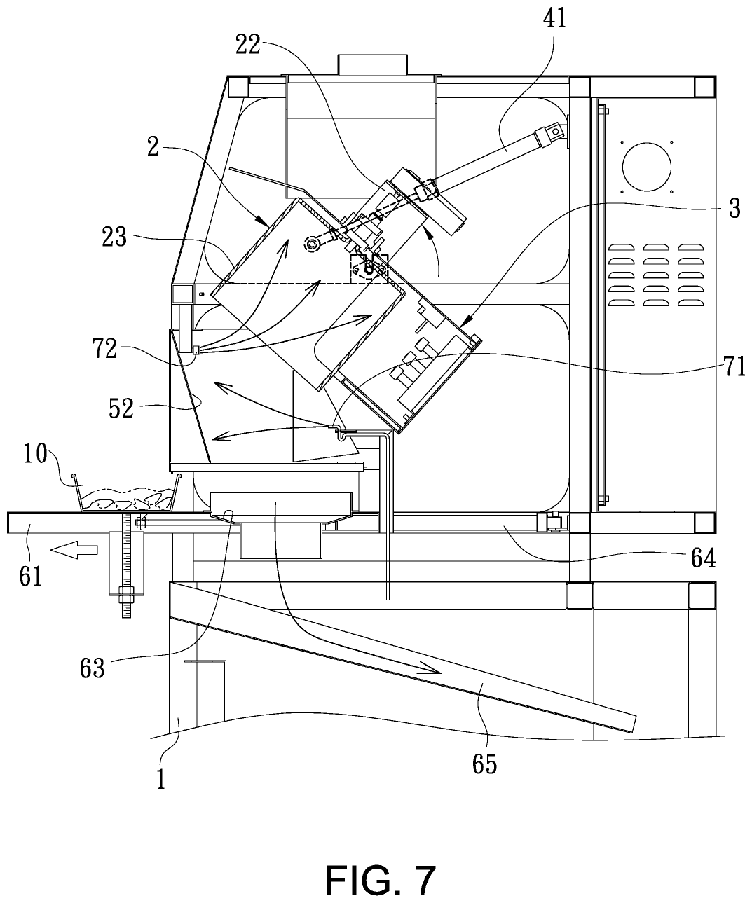

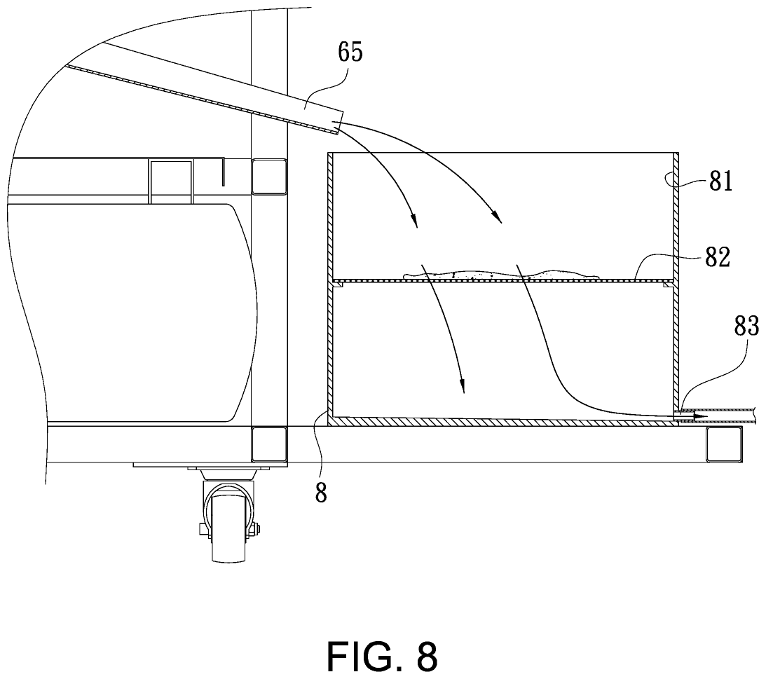

Please refer to FIG. 7. When the tray platform 61 is pushed forward by the second driving source 64 out of the stand 1, the stir-frying drum washing pipeline 72 disposed behind the tray platform 61 is moved to be under the material guiding hopper 62. After that, the main controller 95 of the controller 9 drives the water source 73 of the cleaning unit 7 to supply water, the outlet of the material guiding hopper washing pipeline 71 sprays water toward the material guiding hopper 52 to wash the inner wall of the material guiding hopper 52 to remove food residue attached on the inner wall of the material guiding hopper 52. The material guiding hopper washing pipeline 71 and the stir-frying drum washing pipeline 72 simultaneously spray water toward the inner wall of the chamber 231 of the stir-frying drum 23. The stir-frying drum 23, which is as high as 200 degrees Celsius just after cooking, will instantly vaporize the water to achieve the automatic cleaning effect of the stir-frying drum 23. As a result, food in either of the material guiding hopper 52 and the stir-frying drum 23 can be completely cleaned to prevent from pollute the next dish. As for the waste water after washing the material guiding hopper 52 and the stir-frying drum 23 and the food residue removed from the material guiding hopper 52 and the stir-frying drum 23, please refer to FIG. 8, they will flow downward to the kitchen waste draining channel 65 and the kitchen waste separating tank 81 of the kitchen waste collecting unit 8 so that the dryness/wetness separating member 82 of the kitchen waste separating tank 81 can separate food residue and dirty water. The dirty water separated by the dryness/wetness separating member 82 is drained out by the drain tube 83 of the kitchen waste collecting unit 8. A dirty water processing unit is connected to implement the process of oil separation to accomplish the effects of reducing pollution, controlling pests and diseases and facilitating the collection and cleaning of food waste. The slidable connection between the stand 1 and the material guiding platform 51 of the material guiding unit 5 can draw the material guiding platform 51 out of the stand 1 to sufficiently clean the material guiding hopper 52 and the material guiding platform 51. This can avoid food residue to be attached on the material guiding hopper 52 and can improve the healthy safety of the stir-frying machine.

It is noted that when the stir-frying drum 23 is stir-frying food materials, the remote temperature sensor 32 disposed beside the stir-frying drum 23 synchronously detects a temperature of the stir-frying drum 23. When the stir-frying drum 23 has food materials cooked in a predetermined time and the first driving source 41 of the overturning unit 4 forward tilts the stir-frying drum 23 by 45 to 50 degrees to dump the cooked food, the first sensor 91 will send an alarm signal to the main controller 95 to make the main controller 95 temporarily stop each unit and activate the alarm 94 to generate alarm sound and light if the first sensor 91 disposed correspondingly to the stir-frying unit 2 detects that the stir-frying drum 23 does not tilt to the predetermined angle. This will make staff aware to solve the abnormal situation of the stir-frying drum 23. When the stir-frying drum 23 dumps food in container 10 on the tray platform 61 via the material guiding hopper 52 and the second driving source 64 pushes the tray platform 61 and the container 10 forward, the second sensor 92 will send an alarm signal to the main controller 95 if the second sensor 92 detects that either of the tray platform 61 and the container 10 does not reach the predetermined position. When the second driving source 64 moves the tray platform 61 and the container 10 to return the original position and the second sensor 92 detects that either of the tray platform 61 and the container 10 does not return, the second sensor 92 will also send an alarm signal to the main controller 95. The alarm signal makes the main controller 95 temporarily stop each unit and activate the alarm 94 to generate alarm sound and light. This will make staff aware to solve the abnormal situation. When the rotary power source 22 of the stir-frying unit 2 rotates the stir-frying drum 23 to stir-fry food materials, the third sensor 93 will sense a current load of the rotary power source 22 of the stir-frying unit 2. When a current of the rotary power source 22 is abnormal, it means the rotary power source 22 works abnormally. At this time, the third sensor 93 will send an alarm signal to the main controller 95 to make the main controller 95 temporarily stop each unit and activate the alarm 94 to generate alarm sound and light. This will make staff aware to solve the abnormal situation of the rotary power source 22 of the stir-frying unit 2 working abnormally.

The abovementioned embodiment or figures do not limit the modes of the invention. The operating unit 96 of the invention is electrically connected with not only the main controller 95 of one stir-frying machine but also the main controllers 95 of more than two stir-frying machines. Thus, a worker can send an operation command to more than two stir-frying machines through one operating unit 96 to increase convenience in operation. While this disclosure has been described by means of specific embodiments, numerous modifications and variations could be made thereto by those skilled in the art without departing from the scope and spirit of this disclosure set forth in the claims.

As can be seen from the above structure and implementation, the present invention has the following advantages:
1. The food dumped by the stir-frying drum falls in the container on the tray platform via the material guiding hopper and the driving source pushes the tray platform out of the stand, the stir-frying drum washing pipeline 72 disposed behind the tray platform is moved to the material guiding hopper to wash the inner wall of the material guiding hopper. The material guiding hopper washing pipeline and the stir-frying drum washing pipeline simultaneously spray water toward the stir-frying drum. Thus, food in either of the material guiding hopper and the stir-frying drum can be completely cleaned to prevent from pollute the next dish.
2. When the food materials have been cooked to be food, the food falls in the container placed on the tray platform through the material guiding hopper. After the food falls in the container completely, the driving source of the outputting unit pushes the tray platform forward to push the container on the tray platform and the food therein out of the stand. Thus, the food can be easily taken.
3. The chamber of the stir-frying drum is integratedly connected with a stirrer. The stirrer can lift a large amount of food materials in the drum, the time the lifted food materials stay in air will be extended and the falling speed of the food materials will be reduced. This can promote the food materials to be evenly heated.
4. The stirrer of the stir-frying machine of the invention is of a single blade shape and its bottom length is slightly greater than a bottom radius of the chamber to reach an aslant front position, so that a stirrer with an optimum size is obtained. This makes the food materials generate a maximum tilt degree of freedom in the stir-frying drum. The optimum size and shape design has been carried out through more than 20 kinds of various shapes such as sheet, rod, nail, wall block and irregular with different lengths, widths, sizes, and thicknesses. The best design is obtained from combinatorial testing.
5. In the stir-frying machine of the invention, the stirrer is integrally formed in the chamber of the stir-frying drum. The stir-frying drum and the stirrer, which are integrally formed, can improve the simplicity and convenience of maintenance and cleaning of the stir-frying drum, and can avoid food materials from being clamped in structural gaps. Also, the integrated formation design can make the stir-frying drum completely close without leakage of juice in the drum or risk of food safety caused by the lubricant outflowing or infiltrating into the drum due to high temperature aging of the rubber ring in the junction, which always occur in the stir-frying drum with the conventional separate structure design.
6. In the stir-frying machine of the invention, the inner walls of the material guiding hopper adopt an inclination angle of 70-75 degrees and the inner walls of the material guiding hopper are coated with a non-stick layer, these can avoid most food residue from being attached on the inner walls of the material guiding hopper. Furthermore, the stir-frying drum washing pipeline can wash the inner walls to completely clean the material guiding hopper without any food residue.
7. When the stir-frying machine of the invention adopts the single stand design, one kitchen waste collecting unit is disposed under the single stand. When adopting the multiple stands design, one kitchen waste collecting unit is disposed under the outputting units of the stands to accomplish the effect of easily collecting kitchen waste.
8. In the stir-frying machine of the invention, the material guide platform of the material guiding unit and the stand form a slidable connection. Thus, the material guiding platform can be drawn out of the stand to be convenient to completely clean the material guide platform and the material guiding hopper to avoid food residue from being attached on the material guide hopper. This can improve the healthy safety of the stir-frying machine in use.

What is claimed is:

1. A stir-frying machine comprising:
at least one stand;
a stir-frying unit, disposed with a base rotatably connected to the stand, the base being disposed with a rotary power source, and a spindle of the rotary power source being connected with a stir-frying drum;
a heating unit, installed on the base and under the stir-frying drum, and disposed with a heating source;
an overturning unit, installed on the stand, disposed with a first driving source, and an output shaft of the first driving source connecting with the base;
a material guiding unit, comprising a material guiding platform under the base of the stir-frying unit, a central portion of the material guiding platform being disposed with a material guiding hopper, and two sides of the material guiding platform being fixed to the stand;
an outputting unit, comprising a tray platform under the material guiding unit and a second driving source installed on the stand, the tray platform being formed with a container placing space and a cleaning hopper, each of two sides of the tray platform being fixed to one of two inner walls of the stand with a sliding unit to make the tray platform and the stand form a slidable connection, and an output shaft of the second driving source connecting with the tray platform; and
a cleaning unit, comprising a material guiding hopper washing pipeline and a stir-frying drum washing pipeline, the material guiding hopper washing pipeline being disposed behind the tray platform and extending to a position over the cleaning hopper, an outlet of the material guiding hopper washing pipeline being toward the material guiding hopper, a stir-frying drum washing pipeline the stir-frying drum washing pipeline being disposed at a front of the stand and extending to a position over the material guiding hopper, and an outlet of the stir-frying drum washing pipeline being toward the stir-frying drum.

2. The stir-frying machine of claim 1, wherein inner walls of the material guiding hopper of the material guiding unit form an inclination angle of 70-75 degrees from top to bottom, and the inner walls of the material guiding hopper are coated with a non-stick layer.

3. The stir-frying machine of claim 1, wherein each of two sides of the material guiding platform of the material guiding unit is fixed to the stand through a sliding unit to make the material guiding platform and the stand form a slidable connection.

4. The stir-frying machine of claim 1, wherein the stir-frying drum is formed with a chamber, a bottom of the chamber is closed, a top of the chamber, which is opposite to the bottom, is formed with an opening, a chamber height is formed between the top of the chamber and the opening of the chamber, the chamber of the stir-frying drum is provided with a stirrer, the stirrer and the stir-frying drum are integratedly formed in one piece, a side of the stirrer, which is adjacent to an inner wall of the chamber of the stir-frying drum is defined as a first side, the first side is integratedly connected with the inner wall of the chamber, a junction between the first side of the stirrer and the chamber of the stir-frying drum forms an arcuate chamfer, a length of the first side of the stirrer is not greater than the chamber height of the chamber of the stir-frying drum, another side of the stirrer, which is opposite to the first side of the stirrer, is defined as a second side, the second side is integratedly formed with a spatula sheet with an angle against the stirrer, a side of the stirrer, which is adjacent to the bottom of the chamber of the stir-frying drum is defined as a third side, the third side is integratedly connected with the bottom of the chamber of the stir-frying drum, and a length of the third side is greater than a radius of the bottom of the chamber.

5. The stir-frying machine of claim 1, further comprising a first sensor, a second sensor, a third sensor, an alarm and a main controller, wherein the first sensor, the second sensor, the third sensor, the alarm and the main controller are installed on the stand, the first sensor is disposed at a position corresponding to the stir-frying unit for sensing if the stir-frying drum rotates or not, the second sensor is disposed at a position corresponding to the tray platform and the container on the tray platform for sensing if the container is placed on the tray platform or not, the third sensor is installed on the main controller for sensing a current load of the rotary power source of the stir-frying unit, the main controller has a built-in automatic stir-frying program, and the first sensor, the second sensor, the third sensor, the alarm, the rotary power source of the stir-frying unit, the first driving source of the overturning unit and the second driving source of the outputting unit are wiredly or wirelessly connected with the main controller.

6. The stir-frying machine of claim 5, wherein a remote temperature sensor is disposed at a position of the base, which corresponds to the stir-frying drum, there is a distance between the remote temperature sensor and the stir-frying drum to detect a stir-frying temperature of the stir-frying drum, the remote temperature sensor is connected to the heating source, a temperature of the heating source is controlled by the remote temperature sensor, and the remote temperature sensor is wiredly or wirelessly connected with the main controller of the control unit.

7. The stir-frying machine of claim 5, wherein the material guiding hopper washing pipeline and the stir-frying drum washing pipeline of the cleaning unit are connected with a water source, and the water source is wiredly or wirelessly connected with the main controller of the control unit.

8. The stir-frying machine of claim 5, further comprising an operating unit wiredly or wirelessly connected with the main controller of the control unit.

9. The stir-frying machine of claim 1, wherein the stand is connected with a kitchen waste draining channel under the tray platform, the kitchen waste draining channel is arranged aslant from top to bottom, a kitchen waste collecting unit is disposed under the kitchen waste draining channel, the kitchen waste collecting unit is formed with a kitchen waste separating tank, a dryness/wetness separating member is disposed in the kitchen waste separating tank, and a bottom of the kitchen waste collecting unit is connected with at least one drain tube communicating with the kitchen waste separating tank.

10. The stir-frying machine of claim 1, wherein the stand is multiple in number, the stands are arranged in parallel, each stand is connected with a kitchen waste draining channel under the tray platform, each kitchen waste draining channel is arranged aslant from top to bottom, a kitchen waste collecting unit is jointly disposed under the kitchen waste draining channels, the kitchen waste collecting unit is formed with a kitchen waste separating tank, a dryness/wetness separating member is disposed in the kitchen waste separating tank, and a bottom of the kitchen waste collecting unit is connected with at least one drain tube communicating with the kitchen waste separating tank.
